(19) United States
(12) Patent Application Publication
(10) Pub. No.: US 2022/0324345 A1
(43) Pub. Date: Oct. 13, 2022

(54) POSITIONING UNIT AND CONTACTING METHOD

(71) Applicants: SCHUNK TRANSIT SYSTEMS GMBH, Wettenberg (DE); SCHUNK TRANSIT SYSTEMS GMBH, Nussdorf am Haunsberg (AT)

(72) Inventors: Martin FELDINGER, Seekirchen am Wallersee (AT); Nils HEIEIS, Lich (DE); Timo STAUBACH, Herbstein (DE)

(21) Appl. No.: 17/638,304

(22) PCT Filed: Sep. 28, 2019
(86) PCT No.: PCT/EP2019/072936

§ 371 Date: Feb. 25, 2022

(51) Int. Cl. B60L 53/36; B60L 53/16; B60L 53/31; B60L 53/30

(52) U.S. Cl. CPC B60L 53/36; B60L 53/16; B60L 53/31; B60L 53/32; B60L 2200/18

(57) ABSTRACT

A positioning unit for electrically driven vehicles and a method for forming an electrically conductive connection between an electrically driven vehicle and a stationary charging station having a positioning unit configured to be disposed on a vehicle roof. The positioning unit includes a contact device that is moveable relative to a charging contact device of the charging station and is electrically connectable to the charging contact device in a contact position, and an articulated arm device for positioning the contact device and a drive device for driving the articulated arm device. The articulated arm device includes for pivoting the contact device from a storing state to a vertical contact state and vice versa, and a second pivot arm for pivoting the contact device from the retracted position to the contact position and vice versa. The first pivot arm is disposed to be pivotable on a distal end of the second pivot arm.

This application represents the national stage entry of PCT International Patent Application No. PCT/EP2019/072936 filed on Aug. 28, 2019, the contents of which are hereby incorporated by reference as if set forth in their entirety herein.

The disclosure relates to a positioning unit for electrically driven vehicles, in particular for electric busses or the like, and to a method for forming an electrically conductive connection between an electrically driven vehicle and a stationary charging station, the positioning unit being configured to be disposed on a vehicle roof, a contact device of the positioning unit being moveable relative to a charging contact device of the charging station and being electrically connectable to said charging contact device in a contact position, the positioning unit having an articulated arm device for positioning the contact device and a drive device for driving the articulated arm device.

Positioning units and methods of this kind are known from the state of the art and are regularly used for electrically driven vehicles which, for example, operate between bus stops. These vehicles can be electric busses or even different vehicles, such as a train or a tram, which are not permanently connected to an overhead wire or the like. The electrical energy storage of these vehicles is charged by a charging station while the vehicle stops at a bus stop. At the bus stop, the vehicle is electrically connected to the charging station, whereby the energy storage is recharged at least enough so the vehicle can reach the next station equipped with a charging station. It is also possible to supply the vehicle with electrical energy outside of operating hours in this manner.

To establish an electrical connection between the vehicle and the charging station, a positioning unit is used which can be mounted on a vehicle roof and connects a contact device of the vehicle to a charging contact device of the charging station above the vehicle. Contact surfaces of the contact device are then moved towards charging contact surfaces above the vehicle roof and an electrical connection is established.

When guiding the contact device and charging contact device together, it is essential that the contact device can be positioned on the charging contact device comparatively precisely and that said contact device is pressed against the charging contact surfaces using a sufficiently large contact force in order to form a reliable electrical connection. From WO2015/018887, a comparable positioning unit is known. A disadvantage of the known positioning units is that they can contact the charging contact device only at a defined height. When the contact device is lifted by an articulated arm device, the contact device is moved to a vertical position; however, this vertical position is only reached when the contact device is in the intended contact position or at the intended height. Charging contact devices at bus stops are thus always required to have an essentially uniform height above a road or the respective positioning unit on a vehicle must be coordinated with a height of the vehicle or the height of the charging contact devices. It is not easily possible to flexibly dispose charging contact devices along a route, for example under bridges or on poles because a height of the charging contact device above a road is predetermined by the respective structure.

A further disadvantage is that a structural height of the positioning unit can make it impossible to drive under a structure, thus limiting the application range of a vehicle with a positioning unit. Furthermore, for passengers of the respective vehicle, it is desirable if a positioning unit is preferably only visible to a smallest possible extent. Therefore, it is also known to dispose trims on a vehicle roof in order to hide positioning units or in order to integrate them in a vehicle in such a manner that the form of the vehicle still looks appealing to the passengers.

It is therefore the object of the disclosure to propose a positioning unit and a method for forming an electrically conductive connection between an electrically driven vehicle and a stationary charging station which both allow a flexible use of the vehicle.

This object is attained by a positioning unit having the features of claim 1, by a fast charging system having the features of claim 14 and by a method having the features of claim 15.

The positioning unit according to the disclosure for electrically driven vehicles, in particular for electric busses or the like, serves for forming an electrically conductive connection between a vehicle and a stationary charging station, the positioning unit being configured to be disposed on a vehicle roof, a contact device of the positioning unit being moveable relative to a charging contact device of the charging station and being electrically connectable to said charging contact device in a contact position, the positioning unit having an articulated arm device for positioning the contact device and a drive device for driving the articulated arm device, the articulated arm device having a first pivot mechanism having a first pivot arm by means of which the contact device is pivotable from a storing state of a retracted position of the positioning unit for storing the contact device to a vertical contact state of the retracted position and vice versa, the articulated arm device having a second pivot mechanism having a second pivot arm by means of which the contact device is pivotable from the retracted position to the contact position and vice versa, the first pivot arm being disposed so as to be pivotable on a distal end of the second pivot arm.

Accordingly, a movement of the contact device relative to a charging contact device of a charging station disposed above the contact device is carried out by the articulated arm device using the drive device. The contact device can have a number of contacts which are contacted by charging contacts of the charging contact device. For this contacting to take place at all, it is essential that the contact device is in a vertical position in the contact position. The contact device is disposed so as to be pivotable on the distal end of the second pivot arm and can thus be pivoted to the vertical contact state and the storing state. The contact device is then also in the contact position in the vertical contact state. In particular because the first pivot arm having the contact device is disposed so as to be pivotable on the distal end of the second pivot arm, it becomes possible to pivot the contact device or move it to the vertical contact state irrespective of the position of the second pivot arm. This allows the contact device to be positioned at different heights in the vertical contact state, for example with the second pivot arm in a lowered position or storing state or with the second pivot arm to a maximally extended position. This results in a comparatively large area within which the contact device can be moved to a contact position. Thus, it is no longer necessary to dispose different charging contact devices along a route at essentially consistent heights above a road and customize them for one type of vehicle. On account of the comparatively large area in which the contact device can be positioned above the vehicle roof in the contact position, the positioning unit according to the disclosure can be flexibly used for various types of vehicles with varying installation heights of charging contact devices.

The positioning unit can comprise a holding frame for mounting the positioning unit on a vehicle roof, the second pivot arm being disposed so as to be pivotable on the holding frame. The holding frame can form or have fixed bearings for the second pivot arm and the drive device, for example. The holding frame can also be particularly easily mounted on a vehicle roof. For example, a mounting can be carried out via damper elements which damp vibrations and/or movements of the vehicle.

By means of the articulated arm device, the contact device can be vertically and horizontally positioned relative to the charging contact device and moved to the contact position. In particular when the first pivot arm is pivoted relative to the second pivot arm, and the second pivot arm is pivoted relative to a vehicle roof, the contact device is moved at least within a radius or a circular path around a pivot bearing of the respective pivot arm, which causes a horizontal displacement of the contact device while simultaneously causing a vertical displacement. In this respect, it is also advantageous if the charging contact device is formed such that it can be contacted horizontally by the contact device at different positions. For example, the positioning unit can be mounted on a vehicle roof such that the movement takes place in the horizontal direction along a moving direction of the vehicle.

The drive device can have a first adjustment drive for generating an adjustment force which acts on the first pivot arm and for forming a first spring member which mechanically interacts with the first adjustment drive. The first adjustment drive can interact such with the first spring member that the adjustment force alone can cause a movement of the first pivot arm having the contact device. The first adjustment drive can directly interact with the first spring member or be connected to the pivot arm by interposing a further mechanical component, such as a lever.

The first spring member can comprise at least one torsion spring which can be disposed on a pivot axis connecting the first pivot arm and the second pivot arm. The torsion spring can exert an adjustment force on the first pivot arm in such a manner that said first pivot arm is moved to the storing state or, alternatively, to a contact state by the torsion spring. For example, it can be envisaged that the torsion spring moves the contact device to the storing state in case of a failure of the first adjustment drive to possibly prevent a faulty contacting. In principle, any other type of spring, such as a spring rod, can be used instead of a torsion spring. A torsion spring can be disposed around the pivot axis in a particularly compact manner.

The first adjustment drive can have an electric motor, a rope drive and/or a chain drive via which the first pivot arm is rotatable on the pivot axis. For example, an electric motor can be disposed directly on the pivot axis or be integrated within it. Furthermore, a tensile force can be exerted on the first pivot arm via a rope drive and/or a chain drive, which is mounted on the pivot axis. Thus, for example two cable pulleys which can pivot the pivot arm by means of a reverse movement can be disposed on the pivot axis. The rope drive or chain drive can also be actuated by means of an electric motor, which can in this case be disposed away from the pivot arms on a holding frame of the positioning unit. Furthermore, a rope drive and a chain drive can also be used in combination. The chain drive can be formed by a chain which extends over a toothed wheel on the pivot axis and is connected to a cable pulley or Bowden cable at its respective ends.

The drive device can have a second adjustment drive for generating an adjustment force which acts on the second pivot arm and for forming a second spring member which mechanically interacts with the adjustment drive. The second adjustment drive can be connected to the second spring member directly or by interposing a further mechanical component, such as a lever. The second adjustment drive can have an electric motor or a linear drive, preferably a spindle drive. The second adjustment drive can have a displacement sensor which can be an incremental encoder or an absolute encoder. This makes it possible to determine an exact operating position of the second adjustment drive at all times. The adjustment drives can also have limit switches that can be operated depending on the position and/or pressure switches that can be operated depending on the force. Furthermore, pressure switches can additionally be used for limiting a contact force or adjustment force.

The second spring member can comprise at least one contact spring, the second adjustment drive and the contact spring being mechanically coupled to each other in series in such a manner that the second adjustment drive and the contact spring are configured to generate a contact force on a contact surface. By mechanically coupling the second adjustment drive and the contact spring in series, the articulated arm device or the second pivot arm can be moved using the adjustment force of the second adjustment drive and the adjustment force can be increased further when the contact surface is contacted by a charging contact of the charging contact device. The further increased adjustment force can then be stored by the contact spring which is connected to the second adjustment drive and be transmitted to the contact surface as a contact force. Hence, the adjustment force increase is not used for further moving the articulated arm device but for generating or increasing the contact force on the charging contact surfaces. Thus, an essentially ever-constant contact force can be exerted on the charging contact surfaces irrespective of a height of the charging contact surfaces or the charging contact device above a road or irrespective of a relative distance between the charging contact surfaces and the contact device in a contact position of the contact device. In this case, a change in height, for example because of a load of the vehicle, does not significantly change the contact force, so that a reliable contacting is ensured.

The second pivot arm can be cranked, a section of the second pivot arm forming the distal end being horizontally positionable in a storing state. In the storing state, the second pivot arm can then be placed on a vehicle roof in a particularly compact manner.

In the storing state, the first pivot arm having the contact device can be pivoted towards a proximal end of the second pivot arm and rest thereon. If the second pivot arm is formed so as to be cranked, the first pivot arm having the contact device can rest on the second pivot arm, which is positioned horizontally, in a section of the second pivot arm. Thus, the structural height of the articulated arm device in the storing state can be comparatively low. In principle, however, it is also possible to pivot the first pivot arm having the contact device in the storing state in the opposite direction away from the proximal end of the second pivot arm, the length of the articulated arm device on the roof of the vehicle being comparatively larger in this case. In this respect, it is advantageous to dispose the articulated arm device in the storing state on the roof of the vehicle so as to be as compact as possible.

The contact device is positionable between a lower contact position and an upper contact position using the articulated arm device, a ratio of the structural height of the positioning unit in the storing state to the height of the upper contact position being 1:4, preferably 1:6.5, a ratio of the structural height to the height of the lower contact position being 1:4, preferably 1:3. Thus, there is a large area between the upper contact position and the lower contact position within which a charging contact device can be contacted by the contact device. Simultaneously, the structural height is comparatively small in relation to this area. A vehicle having the positioning unit can then also drive under a comparatively larger number of structures, such as bridges, thus allowing a more flexible use of the vehicle.

The contact device can have a contact element carrier having contact elements, the contact elements each being electrically connectable to charging contact elements of the charging contact device in the contact position for forming contact pairs. The contact element carrier can be formed such that the contact elements are disposed on an upper side of the contact element carrier in the vertical contact state of the contact device. The charging contact elements can be conductor strips, for example, which are disposed on a roof-shaped charging contact element carrier of the charging contact device.

The first pivot mechanism can have a transverse guide by means of which the contact device is transversely positionable relative to the charging contact device, the transverse guide being disposed on a distal end of the first pivot arm. Consequently, the contact device can be displaced transversely to the moving direction of the vehicle on the distal end of the first pivot arm. This displaceability allows, for example, a wrong positioning of the vehicle at a bus stop transverse to the direction of travel to be compensated. Furthermore, possible vehicle movements because of a one-sided lowering of the vehicle for people entering and exiting the vehicle can be compensated in such a manner that the contact device cannot become displaced in the transverse direction relative to the charging contact device. Furthermore, no shear forces act on the first pivot arm and the second pivot arm in this case. The transverse guide can be a straight linear guide or even a curved linear guide. The contact device can be disposed on the transverse guide so as to be freely displaceable, the transverse guide being a guide bar or being formed having guiding profiles for the contact device. Furthermore, the contact device can be centered on the transverse guide, i.e., be disposed so as to be centered relative to the transverse guide by means of springs in a resting position or in a position without contact, for example.

The fast charging system according to the disclosure comprises a charging contact device and a positioning unit according to the disclosure. Further advantageous embodiments of the fast charging system are apparent from the description of features of the dependent claims referring back to claim 1.

In the method according to the disclosure for forming an electrically conductive connection between an electrically driven vehicle, in particular an electric bus or the like, and a stationary charging station having a positioning unit, a contact device of the positioning unit is moved relative to a charging contact device of the charging station and electrically connected to said charging contact device in a contact position, the contact device being positioned by means of an articulated arm device of the positioning unit and the articulated arm device being driven by means of a drive device of the positioning unit, the contact device being pivoted from a storing state of a retracted position of the positioning unit for storing the contact device to a vertical contact state of the retracted position by means of a first pivot mechanism of the articulated arm device using a first pivot arm, the contact device being pivoted from the retracted position to the contact position by means of a second pivot mechanism of the articulated arm device using a second pivot arm, the first pivot arm being disposed and pivoted on a distal end of the second pivot arm. For further details on the advantageous effects of the method according to the disclosure, reference is made to the description of advantages of the positioning unit according to the disclosure.

The contact device can be pivoted first from the storing state to the vertical contact state and then from the vertical contact state to the contact position and vice versa. The positioning unit can then have a minimal structural height in the storing state. When driving towards a bus stop with a vehicle, the contact device can then be pivoted from the storing state to the vertical contact state in a first step.

Furthermore, during a pivoting of the contact device using the second pivot arm, the first pivot mechanism can always position the contact device in the vertical contact state. After the contact device has been pivoted to the vertical contact state, the contact device can be lifted in the vertical contact state and moved against a charging contact device in a second step by pivoting the first pivot arm having the contact device using the second pivot arm. It is advantageous if during the pivoting of the second pivot arm, the first pivot arm or the contact device is always vertically positioned or if the first pivot arm is pivoted relative to the second pivot arm. This simultaneous movement of the first pivot arm and the second pivot arm can be caused by a suitable mechanism or control of the drive device. In any case, it thus becomes possible to contact the contact device in the correct position by means of a charging contact device in an area between an upper contact position and a lower contact position.

Further advantageous embodiments of the method are apparent from the description of features of the dependent claims referring back to claim 1.

Hereinafter, a preferred embodiment of the disclosure will be described in more detail with reference to the accompanying drawings.

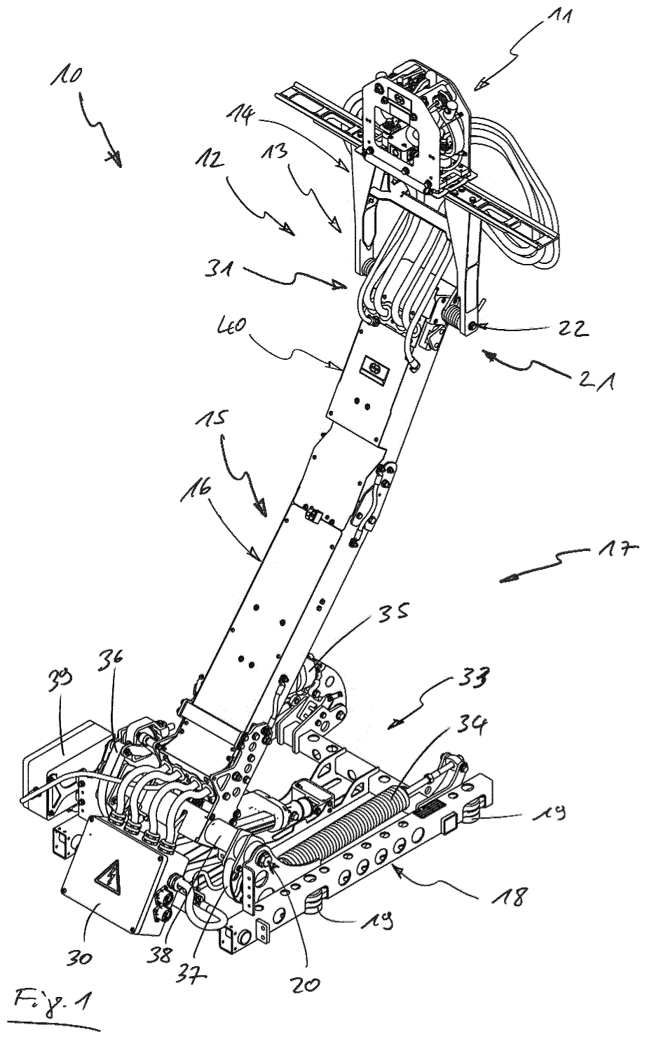

FIG. 1 is a perspective view of a positioning unit;

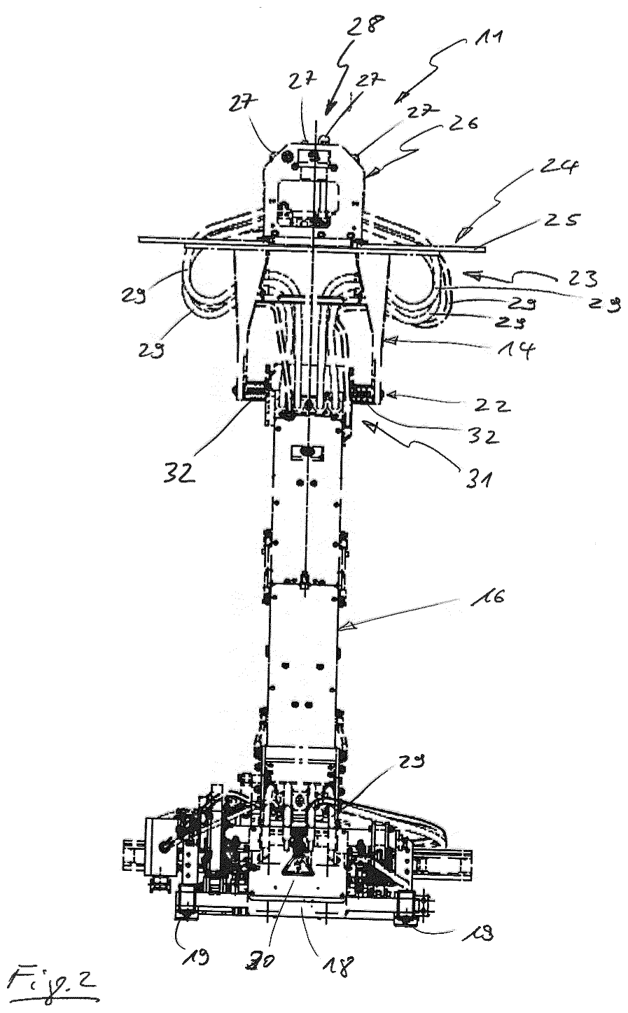

FIG. 2 is a front view of the positioning unit;

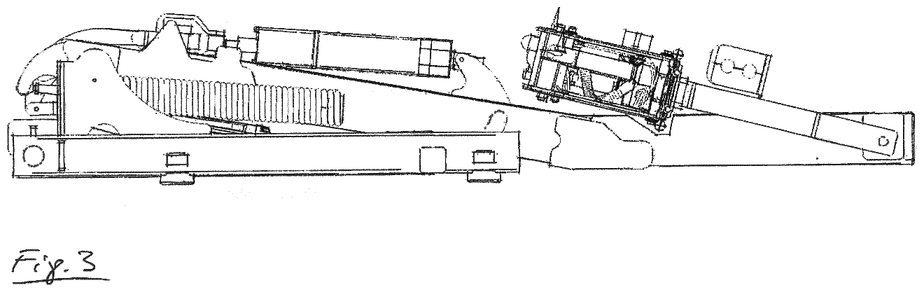

FIG. 3 is a side view of the positioning unit in a storing state of a retracted position;

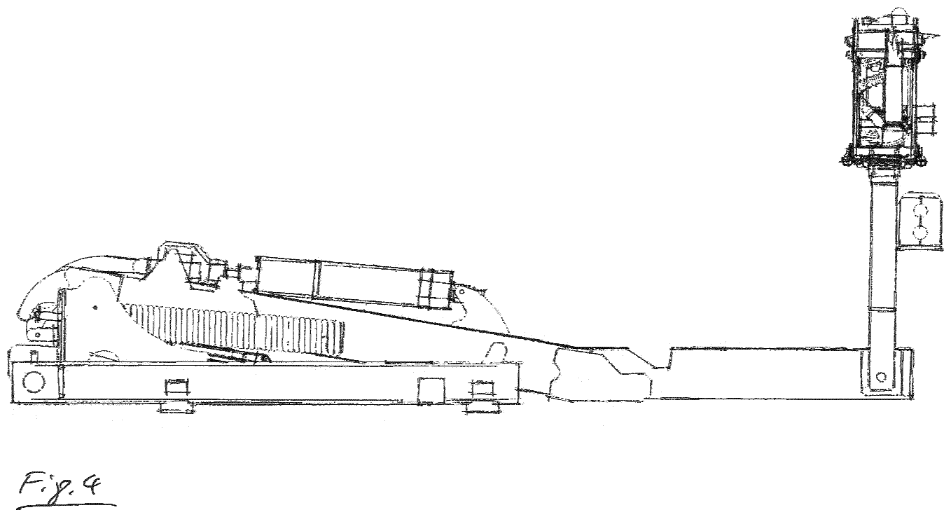

FIG. 4 is a side view of the positioning unit in a vertical contact state of the retracted position;

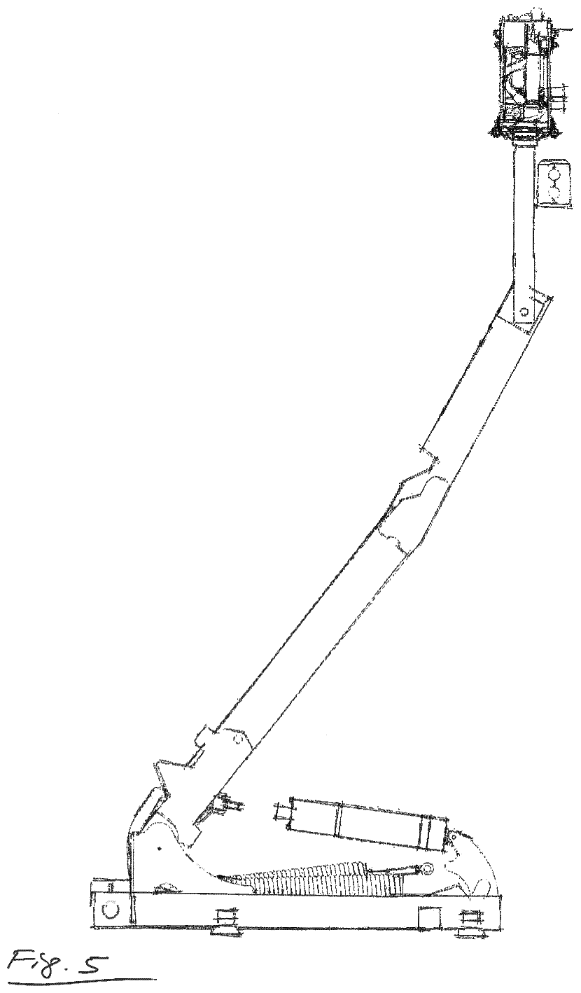

FIG. 5 is a side view of the positioning unit in a vertical contact state of a contact position;

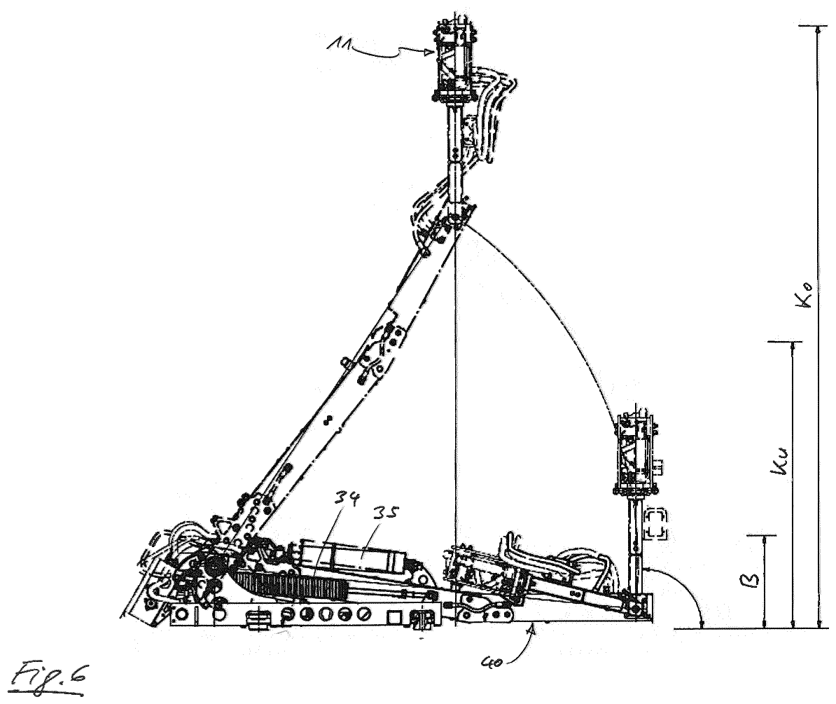

FIG. 6 is a side view of the positioning unit in different positions.

A combined view of FIGS. 1 to 6 shows a positioning unit 10 which is mounted on a roof of a vehicle (not illustrated), in particular an electric bus. Positioning unit 10 comprises a contact device 11 for forming an electrical contact with a charging contact device (not illustrated) of a charging station. The charging contact device is suspended above the vehicle roof and contact device 11 in the area of a bus stop of the vehicle by means of a suspension device (not further illustrated). Positioning unit 10 further comprises an articulated arm device 12, which is formed by a first pivot mechanism 13 having a first pivot arm 14 and by a second pivot mechanism 15 having a second pivot arm 16, and a drive device 17 for driving articulated arm device 12.

Furthermore, positioning unit 10 has a holding frame 18 for mounting positioning unit 10 on the vehicle roof via damper elements 19. A pivot bearing 20 is formed on holding frame 18, second pivot arm 16 being mounted on said pivot bearing 20 so as to be pivotable. On a distal end 21 of second pivot arm 16, a pivot axis 22 is formed around which first pivot arm 14 can be pivoted. Contact device 11 is disposed on a distal end 23 of first pivot arm 14. Furthermore, contact device 11 is moveable transversely relative to the charging contact device (not illustrated) on a transverse guide 24 of first pivot mechanism 13. Transverse guide 24 is formed by a rail 25 which is mounted on distal end 23.

Contact device 11 is formed by a contact element carrier 26 having contact elements 27 which are spring-mounted thereon. Contact elements 27 are disposed on an upper side 28 of contact element carrier 26. Contact elements 27 are connected to a junction box 30 on holding frame 18 via flexible cables 29.

Drive device 17 comprises a first adjustment drive 31 for generating an adjustment force acting on first pivot arm 14, first adjustment drive 31 comprising torsion springs 32 which are disposed on pivot axis 22. Furthermore, first adjustment drive 31 comprises a rope and chain drive (not further illustrated), which is formed by a chain and two cable pulleys. The chain meshes in a toothed wheel (not illustrated) on pivot axis 22 and can be actuated via the cable pulleys such that first pivot arm 14 can be pivoted.

Furthermore, drive device 17 has a second adjustment drive 33 for generating an adjustment force acting on second pivot arm 16. Second adjustment drive 33 comprises a spring 34 and a linear drive 35 via which the adjustment force can be exerted on second pivot arm 16 in cooperation with spring 34. Spring 34 and linear drive 35 engage in a pivot axis 38, which is disposed in pivot bearing 20, via levers 36 or 37. First adjustment drive 31 and second adjustment drive 33 are actuated by a control 39 which is disposed on holding frame 18 in this case.

A charging contact device is contacted by contact device 11 starting from the storing state of a retracted position of articulated arm device 12 illustrated in FIG. 3. In a first step, first pivot arm 14 is moved to a vertical contact state of the retracted position which is illustrated in FIG. 4. In a second step, second pivot arm 16 is lifted, first pivot arm 14 remaining vertical at all times or being disposed in the vertical contact state. Thus, contact device 11 can be positioned between an upper contact position Ko and a lower contact position Ku or in a contact area, in which an electrical contact can be formed in any case using a charging contact device. Likewise, it is possible that positioning unit 10 has a comparatively low structural height B in the storing state. Second pivot arm 16 is cranked in order to reduce structural height B, such that a section 40 of second pivot arm 16 is positioned horizontally in the storing state and first pivot arm 14 having contact device 11 can rest on section 40 in a compact manner.

1. A positioning unit for electrically driven vehicles for forming an electrically conductive connection between a vehicle and a stationary charging station, the positioning unit being configured to be disposed on a vehicle roof, a contact device of the positioning unit being moveable relative to a charging contact device of the charging station and being electrically connectable to said charging contact device in a contact position, the positioning unit having an articulated arm device for positioning the contact device and a drive device for driving the articulated arm device,
wherein
the articulated arm device has a first pivot mechanism having a first pivot arm by means of which the contact device is pivotable from a storing state of a retracted position of the positioning unit for storing the contact device to a vertical contact state of the retracted position and vice versa, the articulated arm device having a second pivot mechanism having a second pivot arm by means of which the contact device is pivotable from the retracted position to the contact position and vice versa, the first pivot arm being disposed so as to be pivotable on a distal end of the second pivot arm.

2. The positioning unit according to claim 1, wherein the positioning unit comprises a holding frame for mounting the positioning unit on a vehicle roof, the second pivot arm 16 being disposed so as to be pivotable on the holding frame.

3. The positioning unit according to claim 1, wherein by means of the articulated arm device, the contact device is vertically and horizontally positionable relative to the charging contact device and moveable to the contact position.

4. The positioning unit according to claim 1, wherein the drive device has a first adjustment drive for generating an adjustment force which acts on the first pivot arm and for forming a first spring member which mechanically interacts with the first adjustment drive.

5. The positioning unit according to claim 4, wherein the first spring member comprises at least one torsion spring which is disposed on a pivot axis connecting the first pivot arm and the second pivot arm.

6. The positioning unit according to claim 4, wherein the first adjustment drive has an electric motor, a rope drive and/or a chain drive via which the first pivot arm is rotatable on the pivot axis.

7. The positioning unit according to claim 1, wherein the drive device has a second adjustment drive for generating an adjustment force which acts on the second pivot arm and for forming a second spring member which mechanically interacts with the second adjustment drive.

8. The positioning unit according to claim 7, wherein the second spring member comprises at least one contact spring, the second adjustment drive and the contact spring being mechanically coupled to each other in series in such a manner that the second adjustment drive and the contact spring are configured to generate a contact force on a contact surface.

9. The positioning unit according to claim 1, wherein the second pivot arm is formed so as to be cranked, a section of the second pivot arm forming the distal end being horizontally positioned in a storing state.

10. The positioning unit according to claim 1, wherein in the storing state, the first pivot arm having the contact device is pivoted towards a proximal end of the second pivot arm and rests thereon.

11. The positioning unit according to claim 1, wherein that the contact device is positionable between a lower contact position and an upper contact position using the articulated arm device, a ratio of the structural height (B) of the positioning unit in the storing state to the height (Ko) of the upper contact position being 1:4, a ratio of the structural height (B) to the height (Ku) of the lower contact position being 1:4.

12. The positioning unit according to claim 1, wherein the contact device 11 has a contact element carrier having contact elements, the contact elements each being electrically connectable to charging contact elements of the charging contact device in the contact position for forming contact pairs.

13. The positioning unit according to claim 1, wherein the first pivot mechanism has a transverse guide by means of which the contact device is transversely positionable relative to the charging contact device, the transverse guide being disposed on a distal end of the first pivot arm.

14. A fast charging system having a charging contact device and a positioning unit 10 according to claim 1.

15. A method for forming an electrically conductive connection between an electrically driven vehicle and a stationary charging station having a positioning unit, a contact device of the positioning unit being moved relative to a charging contact device of the charging station and being electrically connected to said charging contact device in a contact position, the contact device being positioned by means of an articulated arm device of the positioning unit and the articulated arm device being driven by means of a drive device of the positioning unit,
wherein
the contact device is pivoted from a storing state of a retracted position of the positioning unit for storing the contact device to a vertical contact state of the retracted position by means of a first pivot mechanism of the articulated arm device using a first pivot arm, the contact device being pivoted from the retracted position to the contact position by means of a second pivot mechanism of the articulated arm device using a second pivot arm 16, the first pivot arm being disposed and pivoted on a distal end of the second pivot arm.

16. The method according to claim 15, wherein the contact device is first pivoted from the storing state to the vertical contact state and then from the vertical contact state to the contact position and vice versa.

17. The method according to claim 15, wherein during a pivoting of the contact device using the second pivot arm, the first pivot mechanism always positions the contact device in the vertical contact state.

18. The positioning unit according to claim 1, wherein that the contact device is positionable between a lower contact position and an upper contact position using the articulated arm device, a ratio of the structural height (B) of the positioning unit in the storing state to the height (Ko) of the upper contact position being 1:6.5, a ratio of the structural height (B) to the height (Ku) of the lower contact position being 1:3.
